(19) United States
(12) Patent Application Publication
(10) Pub. No.: US 2008/0266893 A1
(43) Pub. Date: Oct. 30, 2008

(54) Lighting Module With Compact Colour Mixing and Collimating Optics

(75) Inventor: Ingo Speier, Saanichton (CA)

Correspondence Address: PHILIPS INTELLECTUAL PROPERTY & STANDARDS, 3 BURLINGTON WOODS DRIVE, BURLINGTON, MA, 01803, US

(73) Assignee: TIR SYSTEMS LTD., Burnaby, British Columbia (CA)

(21) Appl. No.: 10/597,775

(22) PCT Filed: Apr. 6, 2006
(86) PCT No.: PCT/CA06/00502

§ 371 Date: Apr. 8, 2008

Related U.S. Application Data
(60) Provisional application No. 60/669,315, filed on Apr. 6, 2005.
(60) Provisional application No. 60/766,784, filed on Feb. 10, 2006.

(51) Int. Cl. F21V 7/04; F21V 9/00

(52) U.S. Cl. 362/551; 362/231

(57) ABSTRACT

The present invention provides a compact format lighting module that can provide a desired level of mixing and collimating of light generated by multiple light-emitting elements within the lighting module. The lighting module comprises two or more light-emitting elements for generating light having one or more colours, wherein the light-emitting elements can be configured into a closely packed array. The module further comprises a primary optical system enabling light extraction from the light-emitting elements to which it is optically coupled. A secondary optical system that is optically coupled to the primary optical system and is configured to be compatible with the primary optical system and provides a means for mixing and collimating the light extracted from the two or more light-emitting elements.

### FIELD OF THE INVENTION

The present invention relates to the field of lighting and in particular to a lighting module with compact optics configured for colour mixing and collimating of light.

### BACKGROUND

Today's optical design solutions as they relate to LED based luminaries, utilize single colour LED packages and typically only provide primary optics to which secondary or optional tertiary optical systems have to be added to meet the functional requirements. This modular method leads to difficulties in beam collimation, colour mixing and efficiency that can only be overcome with bulky additions making the overall optical design complicated and costly.

Most LED manufacturers supply LED packages that incorporate one LED die which is encapsulated and provided with a primary optic. The manufacturers are trying to span many applications with these standardized products and as a result the products are of very limited utility for lighting purposes. Optics to collimate the single die packages are readily available, but the combination of single die packages, for example red, green and blue packages in order to achieve an adjustable white light source leads to unsatisfactory results for both colour mixing and collimation in a given optical design envelope. On the other hand only a few multi-colour solutions exist that integrate more than one LED in a single package, for example, Osram Ostar or Seoul semiconductor packages. However, these solutions do not address beam collimation and extraction efficiency at satisfactory levels and thus typically cannot provide a satisfactory solution to achieve an efficient, compact adjustable white light source. The technical challenge that is being faced is to achieve sufficient colour mixing and beam collimation at high efficiency and compact size.

Only few white light-emitting lighting modules exist based on multicolour light-emitting diodes such as red, green and blue, for example the ENLUX R30 floodlight. The existing modules achieve either collimation or colour mixing, such as the ENLUX light bulb which can achieve sufficient colour mixing at distant illumination planes, but at the cost of no collimation.

Both U.S. Pat. Nos. 6,200,002 and 6,547,416 address optical designs for effective colour mixing to generate a light beam having chromaticity and illuminance cross sectional profiles of sufficient homogeneity. However, neither addresses issues of packaging density. In consequence, these designs can only generate light beams which have relatively reduced brightness and additionally require optical systems with considerably bigger dimensions.

U.S. Pat. No. 4,964,025 describes an asymmetrical flux extraction cup for an LED illumination lamp that has an asymmetrical limited viewing angle or cutoff angle. The cup has a flat section in the bottom normal to the optical axis, for attachment of the LED. In a cross section of one side of the cup, there is a circular section extending from the flat section to a lower point located at an intersection with a line from the opposite cup lip through a nearest edge point of a top surface of an envelope in which the LED is positioned. Next is a lower parabolic section extending from the lower point to an upper point located at an intersection with a projection of the top surface of the positioning envelope. The lower parabolic section has a vertex at the lower point, an axis projecting through the nearest edge point and the lower point, and a focus at the nearest edge point. Then there is an upper parabolic section extending from the upper point to the cup lip. The upper parabolic section has a vertex at the cup lip, an axis extending through the farthest edge point and parallel to the axis of the lower parabolic section, and a focus located at the farthest edge point of the top surface of the positioning envelope. This optical design is specifically directed to being viewed over a predetermined viewing angle and is specifically designed for automotive stop lights. Therefore this optical design does not address the issues relating to colour mixing.

U.S. Pat. No. 6,644,841 describes a reflector for use with light-emitting devices. Multiple reflective surfaces redirect light emission components of the light-emitting device, for example a light-emitting diode, into a desired direction. The different light emission components include a total internal reflection light emission component. Paired light-emitting devices share common reflector surfaces creating an oval light pattern. Holes in the reflector accommodate electrical components and enhance heat dissipation. A deflector pattern on non-reflector surfaces minimizes sun phantom effect when the reflector is used, for example, in a traffic signal. This optical design is specific to traffic lights which are a single light colour, and therefore this optical design does not address issues relating to colour mixing.

U.S. Pat. No. 5,921,652 describes light-emitting panel assemblies including light-emitting panel members and one or more light sources positioned/embedded in a light transition area, which increases the efficiency of light entering the panel members along the light input area to be emitted from one or more light-emitting surfaces along the length of the panel members. Light may be reflected or refracted by a surface which changes the path of a portion of light such that it enters the input area of the panel member at a more acceptable angle. A uniform light output distribution may be produced by utilizing a pattern of light extracting deformities. This optical design is configured to reflect and refract light along a panel and therefore does not address issues relating to light collimation.

U.S. Pat. No. 5,758,951 describes arrays of vertical cavity surface emitting lasers used for illumination in both infra-red and visible light wavelengths. By using several different arrays, each array generating light of a different wavelength, a replacement for conventional lighting sources can be obtained. The present invention offers lower power consumption and longer operating lifetime than known lighting technologies. This design is configured as a larger optical system and therefore may not be applicable for use in a luminaire design.

U.S. Pat. No. 6,525,464 describes a stacked light-mixing LED which includes a main body, more than one connecting parts, a first chip, and a second chip. Two lights with different wavelength in the visible light spectrum area, such as the yellow light and the blue light, or the green light and the red light, are respectively excited and emitted from the first chip and the second chip. By controlling electrical current and voltage, the two lights respectively excited from the first chip and the second chip can be symmetrically mixed into another wavelength of light in the visible light spectrum area, such white light. This design is specifically related to LED package design wherein multiple LEDs are provided within a single package. This configuration however, does not address the mixing or collimation of the light generated by the LEDs within the package.

U.S. Pat. No. 5,803,579 describes an illuminator assembly having a plurality of LEDs on a vehicular support member in a manner such that, when all of the LEDs are energized, illumination exhibiting a first perceived hue, e.g., blue-green, and projected from at least one of the LEDs overlaps and mixes with illumination exhibiting a second perceived hue, e.g., amber, which is distinct from said first perceived hue and which is projected from at least one of the remaining LEDs in such a manner that this overlapped and mixed illumination forms a metameric white colour and has sufficient intensity and colour rendering qualities to be an effective illuminator. This optical design however does not address the need for collimation of the generated light.

Therefore there is a need for a new compact multi-chip lighting module with colour mixing and collimating optics.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a lighting module with compact colour mixing and collimating optics. In accordance with an aspect of the present invention, there is provided a lighting module comprising: two or mere light-emitting elements for generating light having one or more colours, said two or more light-emitting elements positioned into a closely packed array; a primary optical system optically connected with the two or more light-emitting elements, said primary optical system providing a means for light extraction from the two or more light-emitting elements; and a secondary optical system optically connected with the primary optical system, said secondary optical system for mixing and collimating the light extracted from the two or more light-emitting elements.

### BRIEF DESCRIPTION OF THE FIGURES

FIG. 1A illustrates a light-emitting element configuration comprising one red, two green, and one blue light-emitting elements aligned on a substrate according to one embodiment of the present invention.

FIG. 1B illustrates a light-emitting element configuration comprising one red, one green, one blue, and one amber light-emitting elements aligned on a substrate according to another embodiment of the present invention.

FIG. 1C illustrates a light-emitting element configuration comprising four white light-emitting elements aligned on a substrate according to a further embodiment of the present invention.

FIG. 1D illustrates a light-emitting element configuration comprising two red, three green, one blue, and one amber light-emitting elements aligned on a substrate according to another embodiment of the present invention.

FIG. 1E illustrates a light-emitting element configuration comprising one green, and one blue light-emitting elements, and six white light-emitting elements aligned on a substrate according to another embodiment of the present invention.

FIG. 2A illustrates an elevated cross sectional view of a primary optical system of a lighting module according to one embodiment of the present invention.

FIG. 2B illustrates an elevated cross sectional view of another primary optical system of a lighting module according to one embodiment of the present invention.

FIG. 2C illustrates an elevated cross sectional view of another primary optical system of a lighting module according to one embodiment of the present invention.

FIG. 2D illustrates an elevated cross sectional view of a primary optical system of a lighting module according to one embodiment of the present invention.

FIG. 2E illustrates an elevated cross sectional view of a primary optical system of a lighting module according to one embodiment of the present invention.

FIG. 2F illustrates an elevated cross sectional view of a primary optical system of a lighting module according to one embodiment of the present invention.

FIG. 2G illustrates an elevated cross sectional view of part of a carrier and an attached lighting module according to one embodiment of the present invention.

FIG. 3 illustrates a cross sectional view of a primary optical system together with the light-emitting elements and substrate according to another embodiment of the present invention.

FIG. 4 illustrates a perspective view of a secondary optical element according to one embodiment of the present invention.

FIG. 5A illustrates a bottom view of the secondary optical element of FIG. 4.

FIG. 5B illustrates a cross sectional view of the secondary optical element of FIG. 5A taken along line A-A.

FIG. 5C illustrates a cross sectional view of the secondary optical element of FIG. 5A taken along line B-B.

FIG. 6 illustrates a perspective view of a secondary optical element arrangement formed from a plurality of secondary optical elements of FIG. 4.

FIG. 7 illustrates a perspective view of a portion of the secondary optical element arrangement of FIG. 6.

FIG. 8 illustrates an elevated cross sectional view of a lighting module according to one embodiment of the invention, having the primary optical system as depicted in FIG. 3, and a secondary optical element as depicted in FIG. 4.

FIG. 9 illustrates a perspective view of a final secondary optical clement of the lighting module according to one embodiment of the present invention.

FIG. 10 illustrates an exploded view of a secondary optical system for a lighting module according to one embodiment of the present invention, including the secondary optical element arrangement of FIG. 6 and a plurality of final secondary optical elements of FIG. 9.

FIG. 11A illustrates a circular perpendicular cross sectional shape of a light-pipe or light-guide acting as a secondary optical system according to one embodiment of the present invention.

FIG. 11B illustrates a triangular perpendicular cross sectional shape of a light-pipe or light-guide acting as a secondary optical system according to one embodiment of the present invention.

FIG. 11C illustrates a square perpendicular cross sectional shape of a light-pipe or light-guide acting as a secondary optical system according to one embodiment of the present invention.

FIG. 11D illustrates a hexagonal perpendicular cross sectional shape of a light-pipe or light-guide acting as a secondary optical system according to one embodiment of the present invention.

FIG. 11E illustrates an octagonal perpendicular cross sectional shape of a light-pipe or light-guide acting as a secondary optical system according to one embodiment of the present invention

FIG. 12A illustrates an elevated cross sectional view of a secondary optical system according to one embodiment of the present invention.

FIG. 12B illustrates an elevated cross sectional view of a secondary optical system according to another embodiment of the present invention.

FIG. 12C illustrates an elevated cross sectional view of a secondary optical system according to still another embodiment of the present invention.

FIG. 12D illustrates elevated cross sectional views of secondary optical systems according to yet another embodiment of the present invention.

FIG. 13A illustrates an elevated side view of two lighting modules, each having a separate primary and a secondary optical system according to one embodiment of the present invention

FIG. 13B illustrates an elevated side view of a system comprising two individual primary optical systems and two individual secondary optical systems integrated into one element and a common tertiary optical system according to one embodiment of the present invention.

FIG. 13C illustrates an elevated cross sectional view of a system comprising two individual primary optical systems and a common single integrally formed body providing a secondary optical system according to one embodiment of the present invention.

FIG. 14A illustrates an elevated cross sectional view of a lighting module according to an embodiment of the present invention according to one embodiment of the present invention.

FIG. 14B illustrates a perpendicular cross section of the lighting module as illustrated in FIG. 14A having a substantially circular shape.

FIG. 14C illustrates a perpendicular cross section of the lighting module as illustrated in FIG. 14A having a substantially square shape.

FIG. 15A illustrates an elevated cross sectional view of a lighting module according to another embodiment of the present invention.

FIG. 15B illustrates a perpendicular cross sections through the secondary optical system as illustrated in FIG. 15A having a circular shape.

FIG. 15C illustrates a perpendicular cross sections through the secondary optical system as illustrated in FIG. 15A having a hexagonal shape.

FIG. 16A illustrates an elevated view of a lighting module according to an embodiment of the present invention in which the secondary optical system of the lighting module comprises a multi-functional solid optical element according to one embodiment of the present invention.

FIG. 16B illustrates the perpendicular cross section of the embodiment illustrated in FIG. 16A.

FIG. 17 illustrates an elevated cross sectional view of a lighting module according to another embodiment of the present invention.

### DETAILED DESCRIPTION OF THE INVENTION

### Definitions

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “chromaticity” is used to define the perceived colour impression of light as it is perceived by a human observer according to standards of the Commission Internationale de l'Eclairage.

The term “luminous flux output” is used to define the quantity of luminous flux emitted by a light source according to standards of the Commission Internationale de l'Eclairage.

The term “luminous intensity” is used to define the quantity of luminous flux per unit solid angle emitted by a light source according to standards of the Commission Internationale de l'Eclairage and is typically measured in candela.

The term “luminance” is used to define quantity of luminous flux per unit solid angle and unit area of a light source as it is perceived by a human observer according to standards of the Commission Internationale de l'Eclairage and is typically measured in lumen/steradian/cm².

The term “gamut” is used to define the plurality of chromaticity values that a light source can achieve.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a compact format lighting module that can provide a desired level of mixing and collimating of light generated by multiple light-emitting elements within the lighting module. The lighting module comprises two or more light-emitting elements for generating light having one or more colours, wherein the light-emitting elements can be configured into a closely packed array. The module further comprises a primary optical system enabling light extraction from the light-emitting elements to which it is optically coupled. A secondary optical system that is optically coupled to the primary optical system and is configured to be compatible with the primary optical system and provides a means for mixing and collimating the light extracted from the two or more light-emitting elements. The lighting module may optionally comprise a tertiary optical system optically coupled to the secondary optical system to further manipulate the light after interaction with the secondary optical system.

In one embodiment of the present invention, the primary optical system may be integrally formed with the secondary optical system.

The lighting module of the present invention is designed to be utilized in lighting systems to effectively generate adjustable white or coloured light with a relatively high optical efficiency. The lighting module is also designed to enable colour mixing and beam collimation. Moreover, the optical design of the lighting module utilizes a combination of different white and/or colour light-emitting elements in a relatively compact lighting module design. The lighting module can comprise light-emitting elements which can emit light in different wavelength regimes. Examples of wavelength regimes are red, green, blue, and/or amber or other desired wavelength regimes as would be readily understood. The light-emitting elements in the lighting module can be dimmed such that the lighting module can generate light of independently controllable chromaticity and luminous flux output. The chromaticity of the lighting module can be controlled to generate white light within a predetermined range of correlated colour temperatures (CCT) or it can be controlled to generate any colour within the gamut of the light-emitting elements of the lighting module.

The lighting module can provide effective and efficient light extraction, colour mixing, beam shaping and collimation in an integral design. The configuration of the primary and secondary optical systems can take into account the lighting module geometry, the placement of the light-emitting elements, and the integration of the optical components forming the primary and secondary optical systems.

In one embodiment of the present invention, the secondary optical system can be configured in order to provide ease of arrangement or packing of a plurality of secondary optical systems for integration into a light module for a luminaire, for example. Modular design of the secondary optical system may provide for scalability of the size of a light module formed therewith. For example a circular arrangement of secondary optical systems with a hexagonal perpendicular cross sectional shape may provide for close packing of these secondary optical systems.

### Positioning of Light-Emitting Elements

The lighting module design utilizes closely packaged light-emitting elements, for example, densely mounted LED dies on a substrate. A high packing density of the light-emitting elements can provide for a higher average luminance and reduced Etendue at a smaller input aperture of the lighting module. As a result the lighting module, and in consequence, a luminaire for example, can be more compact, require fewer and smaller optical components and can achieve better collimation and higher luminance within the same mechanical envelope when compared to conventional systems based on individual LED packages. Moreover, light originating from densely packed different colour sources can be more easily mixed into a light beam of desired substantial chromaticity uniformity of the luminous intensity distribution and of desired chromaticity uniformity at the exit aperture of the lighting module.

The lighting module can comprise two or more light-emitting elements. The relative placement of the light-emitting elements and the optical system is important and can affect the effectiveness and efficiency of the lighting module. Closely arranging the light-emitting elements can improve mixing, increase average luminance, and reduce optical losses of the emitted light but can also increase thermal stress which may require a sophisticated thermal management system.

In one embodiment of the present invention the light-emitting elements are substantially closely packed when mounted onto the substrate. This format of light-emitting element positioning can aid in the reduction of the amount of non-radiating surface area imaged or projected through the optical systems associated therewith. In one embodiment of the present invention, the spacing between the light-emitting elements can be less than about twice the longest dimension of the light-emitting element. In another embodiment, the spacing is less than about the longest dimension, and in a further embodiment the spacing is less than about half the longest dimension. In one embodiment the spacing between the light-emitting elements is about 100 μm. In one embodiment of the present invention, the spacing between the light-emitting elements is less than 100 μm.

In one embodiment, one or more red, green, and blue, or red, green, blue, and amber light-emitting elements can be arranged in a two-dimensional lattice, for example, in a square, circular, hexagonal lattice, or can be arranged in any other regular, pseudo-regular, or irregular fashion on surfaces of airy shape. For example, the specific arrangement of light-emitting elements can maximize luminance and reduce Etendue by reduction of spacing between the light-emitting elements. Furthermore specific arrangement can ensure that the individual colours are substantially evenly distributed such that chromaticity uniformity of the intensity distribution and consequently chromaticity uniformity over a plane illuminated by the lighting module is achievable. For example, it can be beneficial for achieving a homogeneous chromaticity, when the arrangement of light-emitting elements for each colour has about a zero total colour momentum relative to the optical axis in axial symmetrical optical systems. The colour momentum of a light source can be defined as the product of its luminous flux and its position vector relative to the origin of a chosen coordinate system, wherein the total colour momentum is the sum of these products over all light-emitting elements of the same chromaticity.

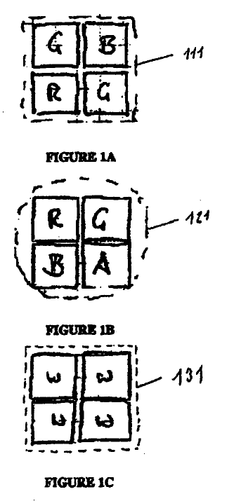

FIGS. 1A, 1B and 1C illustrate light-emitting element configurations according to embodiments of the present invention. FIG. 1A illustrates an alignment of one red light-emitting element, two green light-emitting elements, and one blue light-emitting element as it can be affixed on a substrate. FIG. 1B illustrates an alignment of one red, one green, one blue, and one amber light-emitting element as it can be affixed on a substrate. FIG. 1C illustrates and alignment of four white light-emitting elements as it can be affixed on a substrate. FIG. 1D illustrates an alignment of two red and three green light-emitting elements, and one blue and one amber light-emitting element as it can be affixed on a substrate. FIG. 1E illustrates an arrangement of one green, and one blue light-emitting elements together with six white light-emitting elements as it can be affixed on a substrate. The dashed lines 111, 121, 131, 141 and 151 indicate the size of substantially square, circular, square, octagonal and hexagonal cross sections, respectively of the entrance aperture of the corresponding optical system. It is understood that the optical design of the lighting module can have any other arrangement of any other number of colour or white light-emitting elements associated therewith.

### Primary Optical System

The lighting module comprises a primary optical system enabling efficient light extraction from the light-emitting elements to which it is optically coupled. The primary optical system can include one or more primary optical elements. A primary optical element can be, for example, a refractive element, reflective element, holographic element, diffractive element or the like.

In one embodiment of the present invention, a primary optical element is configured as a micro-lens array having one lenticular element per one or more light-emitting elements or a micro-lens array haying one or more than one lenticular elements for each light-emitting element.

In one embodiment, the refractive element can be manufactured from solid glass, plastic or silicone, or can be a fluid optical element.

In one embodiment, the primary optical system can be specifically tailored to me luminance distribution of the corresponding light-emitting elements to increase light extraction.

In one embodiment the primary optical system can comprise an encapsulation material. To improve light extraction, the light-emitting elements can be encapsulated in an encapsulation material with a predetermined optical refractive index. For example, the encapsulation material can be an optical silicone and have a refractive index of about 1.4 to 2 or higher. The optical refractive index of the encapsulation material can be chosen to match the index of refraction of, for example, the light-emitting elements, a primary optical element of the primary optical system or in between the refractive index of the light-emitting elements and the primary optical element. However, commercially available encapsulation material with suitable optical properties exhibit refractive indices of about 1.4 to 1.6, which can be lower than the refractive indices of the material used to manufacture the light-emitting elements, for example InGaP or AlInGaP semiconductor material. Alternatively the encapsulation can have a predetermined thickness and optical refractive index to increase light extraction. The surface of the light-emitting element can be coated with a layer of encapsulation material of a determined thickness and optical refractive index in order to create an anti-reflective coating comparable to anti-reflective coatings used in optics manufacturing.

In one embodiment the encapsulation material can be patterned or textured, for example, sanded, embossed, stamped, etched or otherwise structured or microstructured. In one embodiment the encapsulation material may be shaped like a dome lens or a micro-lens array by a stamping, casting or moulding process.

In one embodiment the encapsulation material is index matched to the one or more primary optical elements in direct contact to the encapsulation material.

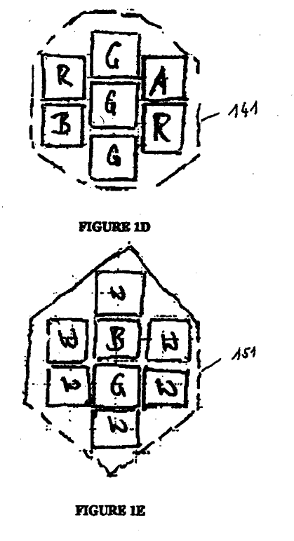

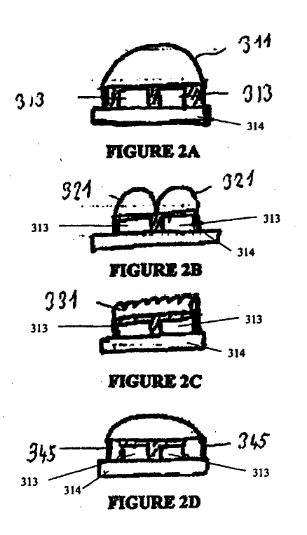

FIGS. 2A, 2B, 2C, 2D, 2E, 2F, 2G and 3 illustrate elevated cross sections of a primary optical system according to embodiments of the present invention. Encapsulation material can be placed between the optical elements and the light-emitting elements to enhance light extraction from the light-emitting elements.

FIG. 2A illustrates an elevated cross sectional view of a primary optical system of a lighting module comprising a dome lens 311 optically communicating with two or more light-emitting elements 313 mounted on a substrate 314.

FIG. 2B illustrates an elevated cross sectional view of a primary optical system of a lighting module comprising one dome lens 321 for each of one or more light-emitting elements 313, the light-emitting elements mounted on a substrate 314.

FIG. 2C illustrates an elevated cross sectional view of a primary optical system of a lighting module comprising a micro lens array 331 optically communicating with two or more light-emitting elements 313, the light-emitting elements mounted on a substrate 314.

FIG. 2D illustrates an elevated cross sectional view of a primary optical system of a lighting module comprising a dome lens optically communicating with two or more light-emitting elements 313 which can have a lateral reflector element 345 circumscribing the light-emitting elements. The light-emitting elements 313 are mounted on a substrate 314.

FIG. 2E illustrates an elevated cross sectional view of a primary optical system of a lighting module comprising an optical encapsulating material having a textured or embossed surface or interface 357. The encapsulation material may be a material with high refractive index and can be embossed or textured by ways well known to someone skilled in the art. The light-emitting elements 313 are mounted on a substrate 314.

FIG. 2F illustrates an elevated cross sectional view of a primary optical system of a lighting module comprising a fluid lens 361 with controllable focal length. The light-emitting elements 313 are mounted on a substrate 314. The fluid lens can be made of, for example, one or more electro-active materials which can be designed to adapt their shape according to an applied electrical field. For example, the focal length can be controlled by applying a voltage to one or more electrodes 369 positioned within the primary optical system. The one or more electrodes can be connected to a controller which can apply and control the voltage between them to create a required electrical field under which the one or more electro active materials shape to form a refractive optical element of adjustable focal length. It is understood that a variable focal length lens can be achieved by utilizing material that changes its refractive index within an electrical field such as a liquid crystal material thereby achieving variable focal length due to refractive index changes within the material instead of a change in shape. In the embodiment illustrated in FIG. 2F, two cavities are illustrated, one filled with encapsulation material enclosing the light-emitting elements and one cavity comprising a fluid lens element.

FIG. 2G illustrates an elevated cross sectional view of part of a carrier 372 and an attached primary optical system comprising an encapsulation material 376 and a dome lens 371 of a lighting module 370. The assembly comprises one or more light-emitting elements 373 mounted to a substrate 374, encapsulated by encapsulation material 376, covered by a dome lens 371 and surrounded by an insert 378. The insert 378 can have a reflective surface facing the light-emitting elements 373. The substrates 374 are mounted inferior to the carrier 372 providing access to the surface facing away from the lighting module thereby providing thermal access, for example. Carrier 372, substrate 374 and primary optical system seal the light-emitting elements from the environment and form a unit.

FIG. 3 illustrates a primary optical system according to one embodiment of the present invention. One or more light-emitting elements 801 are mounted to a substrate 810. The primary optical element, for example a dome lens 800, can be mounted to the substrate 810 and receives the light-emitting elements 801 in a designated pocket. Encapsulation material 820 such as an optical silicone with suitable refractive index can fill the space between the light-emitting elements 801 and the primary optical element or dome lens 800 thereby enhancing the optical extraction efficiency. The primary optical element, namely the dome lens 800 together with the encapsulation material 820 form the primary optical system. The outer surface 880 of the dome lens may be spherical or aspherical; the interior surface 882 can be spherical, aspherical, flat or any other shape as required in the application and known to people skilled in the art. The surfaces can be microstructured for example to aid in colour mixing. In an alternate embodiment, the primary optical element forms, namely the dome lens forms the primary optical system.

It is understood, that each of the lighting modules as illustrated in FIGS. 2A to 2G and FIG. 3 can comprise encapsulation material which can be optically active.

In one embodiment of the present invention, the primary optical system can comprise a solid or hollow light pipe system and aid in the colour mixing.

In one embodiment of the present invention, the primary optical system is integrated into the secondary optical system.

In one embodiment the primary optical system can be designed to aid in colour mixing in addition to light extraction.

### Secondary Optical System

The lighting module further comprises a secondary optical system. The secondary and the primary optical system can be optically coupled or mechanically integrated in one system to minimize light loss between the two systems. The secondary optical system may perform one or more of the following functions. The secondary optical system can provide colour mixing functionality, which can be required in lighting modules with multi-colour light-emitting elements. Alternatively, the secondary optical system can generate a light beam of substantially uniform chromaticity over substantially the entire intensity distribution which can be suitable for illuminating objects at a predetermined distance with light of a predetermined chromaticity or CCT. Furthermore, the secondary optical system can generate a light beam of substantially uniform chromaticity across the exit aperture of the lighting module thereby substantially reducing the appearance of colours in direct view. In addition, the secondary optical system can facilitate beam shaping and can collimate the light beam into a predetermined distribution. For example, for spotlight applications a Gaussian or top hat intensity profile of about 17° FWHM (full width at half maximum) may be created.

The secondary optical system can comprise one or more secondary optical elements. A secondary optical element can be a reflective element, refractive element, diffractive element, diffusive element or the like. For example, a secondary optical element can be a solid or hollow light pipe or light guide for the transmission of light. A secondary optical element can have predetermined axial and perpendicular cross sections. The secondary optical element can comprise refractive elements, for example, one or more lenses, Fresnel lenses, lens arrays, tandem lens arrays, diffractive and holographic elements. The secondary optical element can also comprise diffuser elements or fluid lenses with variable focal lengths to control beam distribution and collimation.

In one embodiment the secondary optical system comprises a hollow or solid lightpipe. This secondary optical system can be designed to minimize the number of times light is reflected when transmitted through this optical system and still provide mixing or randomization of light to provide uniform chromaticity distributions. It is understood that each reflection reduces the light intensity by a reflectivity factor R and therefore after N reflections with the same reflectivity factor R the total reflected intensity I_{N} can be expressed in terms of the original intensity I₀ and can be evaluated based on the following:

I_{N}=I₀·R^{N} (1)

The secondary optical system can have a reflective wall surface and can have a perpendicular and axial cross sectional profile that extends between an entrance aperture and an exit aperture. The reflective wall surface can assist with beam shaping and colour mixing. It is understood, that the cross sectional profiles of the secondary optical element can have an axial symmetric shape or an asymmetric shape or any other desired shape as is known in the art. The axial cross sectional profile can flare or taper towards the exit aperture. Secondary optical systems with square, hexagonal or octagonal perpendicular cross sections can more effectively mix and randomize light than circular or triangular perpendicular cross sections. Consequently, a secondary optical system with square, hexagonal, octagonal or other similar perpendicular cross section can provide better randomization and can have more compact dimensions.

In one embodiment the walls of a secondary optical element are twisted around its optical axis creating a helix like shape.

In one embodiment the curvature of the axial cross sectional profile of the secondary optical system can be parabolic, elliptic, or hyperbolic. Alternatively, the axial cross sectional profile can comprise individual straight or curved continuous conical segments or segmented.

It is also understood that a part of or all of the wall surface of the secondary optical system can be optically active. For example, part of the wall surface can be coated in a phosphor.

In one embodiment the secondary optical system is configured to create a substantially non-rotationally symmetric beam, such as an elliptical beam, a line or beam illuminating a quadrant. These non rotationally symmetric beam shapes can be achieved through non rotationally symmetric reflective secondary optical elements or the application of holographic elements or specifically tailored lenses.

In one embodiment the secondary optical system is configured to create a substantially rotationally symmetric circular spot of light.

In one embodiment, the secondary optical system comprises a secondary optical element that is a refractive element, for example, a dome lens, piano convex lens, a biconvex lens, a Fresnel lens, or a micro lens array which is positioned proximal to the exit aperture defined by the secondary optical system. This refractive element can be an integral part of one of the aforementioned light pipe or light guides, for example. It is understood, that the secondary optical system can also comprise a diffractive, a holographic, a reflective, or a diffusive element proximal to the exit aperture. It is also understood that a diffusive element or aforementioned optical elements can be placed anywhere along the optical path where it is optically appropriate such as proximal to the entrance aperture defined by the secondary optical system. It is also understood mat aforementioned elements can be optically active. For example, part of or all of a surface of a lens placed proximal to the entrance aperture or exit aperture can be coated in a phosphor. Furthermore, any refractive element can also be a controllable variable focal length fluid lens.

In addition, the secondary optical system can be designed, as is known in the art, to leak or direct a small amount of the luminous flux output from each of the lighting modules to one or more photosensitive elements. The photosensitive elements can provide information relating to chromaticity or luminous flux output of the lighting module to a control system. For example, these photosensitive elements can be a photo-sensor, photo-diode or other optically sensitive sensor as would be known by a worker skilled in the art.

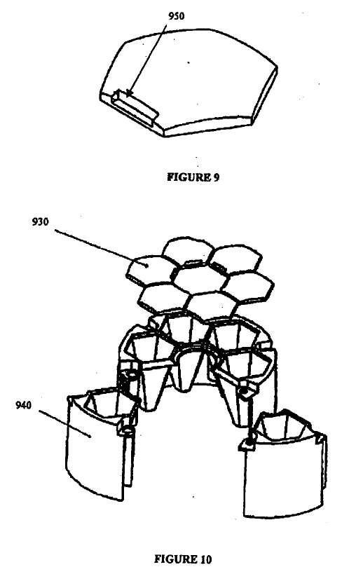

FIGS. 11A-E and 12A-D illustrate various perpendicular cross sectional shapes and longitudinal cross sectional shapes of secondary optical systems, respectively, according to embodiments of the present invention.

FIG. 11 illustrates various embodiments having a circular (FIG. 11A), a triangular (FIG. 11B), a square (FIG. 11C), a hexagonal (FIG. 11D), and an octagonal (FIG. 11E) cross section perpendicular to the overall light propagation of a secondary optical system, for example, a light-pipe or light-guide. In one embodiment, optical elements of square, hexagonal, or octagonal perpendicular cross section are used because they can more effectively mix the emitted light when compared to optical elements having circular or triangular perpendicular cross section.

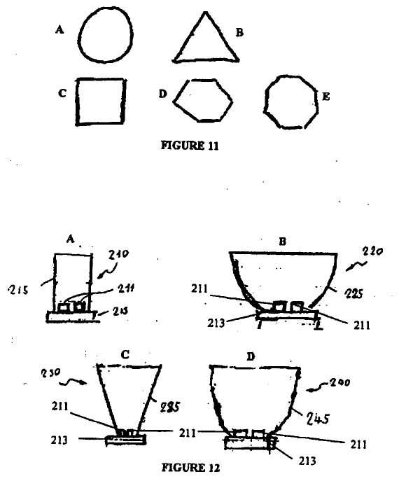

FIG. 12A-D illustrates four axial cross sectional views 210 (FIG. 12A), 220 (FIG. 12B), 230 (FIG. 12C), and 240 (FIG. 12D) of lighting modules each having different cross sections according to the present invention.

FIG. 12A illustrates a lighting module comprising a number of light-emitting elements 211 affixed on a substrate 213 and a hollow or solid secondary optical element 215, for example, a cylindrical hollow body extending from the light-emitting elements.

FIG. 12B illustrates a lighting module comprising a number of light-emitting elements 211 affixed on a substrate 213 and a secondary optical element that is a concave hollow body 225.

FIG. 12C illustrates a lighting module comprising a number of light-emitting elements 211 affixed on a substrate 213 and a secondary optical element that is a conical hollow body 235.

FIG. 12D illustrates a lighting module comprising a number of light-emitting elements 211 affixed on a substrate 213 and a secondary optical element that is a polygonal hollow body 245 with the polygon cross section being created by joining of linear segments.

It is understood that alternatively the secondary optical elements FIG. 12 can be manufactured out of solid acrylic for example and reflect the light based on total internal reflection or be reflectively coated. These secondary optical elements can comprise a mirrored internal surface that can provide for a desired level of reflectivity of the secondary optical system.

In one embodiment a secondary optical element, for example a reflective light pipe, can comprise more than one part for ease of manufacturing. For example, the reflective element of the secondary optical system can be manufactured in two pieces, the two pieces adjoining perpendicular to the optical axis or along the optical axis. In the case that the reflective element comprises two elements that are adjoining perpendicular to the optical axis, the component proximal or distant to the light-emitting elements can also be configured to leak out light to a feed back system.

### Tertiary Optical System

The lighting module according to the present invention may additionally comprise a tertiary optical system following the optical path subsequent to light interacting with the secondary optical system. The tertiary optical system can be designed to further improve beam shaping of the light emitted by one or more lighting modules or adjust beam shaping and colour mixing of the light from one or more secondary optical systems to the requirements of a specific application, for example a specific luminaire design, subsequent to the light's previous interaction with the primary and secondary optical systems. For example, the tertiary optical system can change a rotationally symmetric light beam as prepared by the primary and secondary optical system to a non-rotationally symmetric light beam using holographic diffusers. This further manipulation of the light emitted by the secondary optical system can occur on a luminaire level which can include one or more lighting modules. Alternatively a tertiary optical system may be designed to aid in beam shaping of the light emitted from a specific lighting module. The tertiary optical system can comprise any combination of refractive, reflective, diffractive, diffusive or holographic optical elements and can be used to manipulate light emitted from one or more lighting modules.

The tertiary optical system is optically connected to the secondary optical system. In addition, the tertiary optical system can be designed to physically mate with the secondary optical system. Alternatively, the tertiary optical system may be positioned to be in the optical path of the light emitted from the secondary optical system, for example, be the tertiary optical system can be placed in a luminaire housing in conjunction with an light exit window associated with the luminaire.

The tertiary optical system can be designed to be field replaceable. In this embodiment the lighting module can provide light having a standardized beam distribution and chromaticity uniformity and the tertiary optical system is used to adjust the beam distribution to specific requirements of the application of the lighting module. A standard beam distribution can be about a 17° FWHM Gaussian beam, for example, and a tertiary optic can be designed to increase the beam angle to about 45° comparable to a PAR 30 flood lamp or decrease the beam angle to below about 10° as in a narrow flood lamp, for example. Furthermore, the tertiary optical system can be designed to create a non-rotationally symmetric beam distribution of light, such as a line of light instead of a spot of light or can be designed to illuminate a quadrant of a surface area, for example.

The invention will now be described with reference to specific examples. It will be understood that the following examples are intended to describe embodiments of the invention and are not intended to limit the invention in any way.

### EXAMPLES

### Example 1

FIG. 3 illustrates a primary optical system comprising a primary optical element, namely a dome lens, 800 according to one embodiment of the present invention. This primary optical element, or dome lens 800 can be positioned proximate to the light-emitting elements 801 with which it is associated. The dome lens 800 comprises an outer dome surface 880 and an interior planar surface 882. The dome lens 800 can rest on the substrate 810 to which the light-emitting elements are affixed. In one embodiment, the dome lens 800 mates with the substrate 810, via a mating shoulder 883. The pocket proximal to the bottom of the dome lens 800 can provide room to accommodate the light-emitting elements 801. Encapsulation material 820 such as an optical silicone with suitable refractive index can fill the space between the light-emitting elements and the dome lens thereby enhancing the optical extraction efficiency. In one embodiment, the dome lens together with the encapsulation material form the primary optical system.

In one embodiment, the primary optical system can be optimized for substantially maximum light extraction from the light-emitting elements with which it is optically coupled at substantially a minimal size of the optical clear aperture. Reducing the footprint of the optically clear aperture of the primary optical system, for example the projection of the dome section of the dome lens, can reduce the Etendue and increase average luminance for a benefit of collimation and colour mixing of the lighting module.

In one embodiment, the outer dome surface 880 can provide high extraction efficiency by reducing Fresnel reflections. For example, placement of the emission surfaces of the light-emitting elements 801 close to the center of curvature of the dome lens can provide reduced Fresnel reflections and as a result relatively high extraction efficiency. The outer surface of the lens 880 can be spherical or aspherical shaped. The inner surface 882 can be flat as indicated in FIG. 3 or can be formed to any desired shaped, for example spherically creating a hollow spherical lens. Application of an antireflection coating to the outer surface of the dome lens can further increase extraction efficiency. In addition, the application of a diffusion layer on the outer surface of the dome lens can aid in the colour mixing properties.

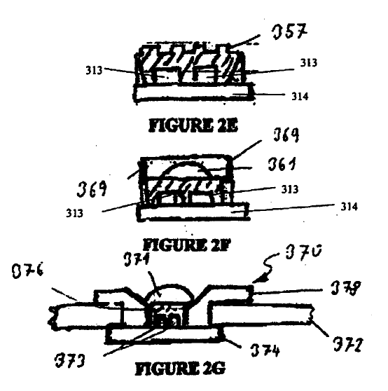

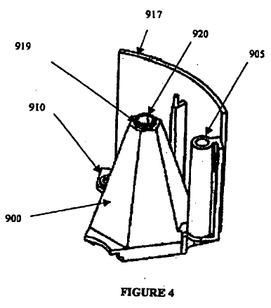

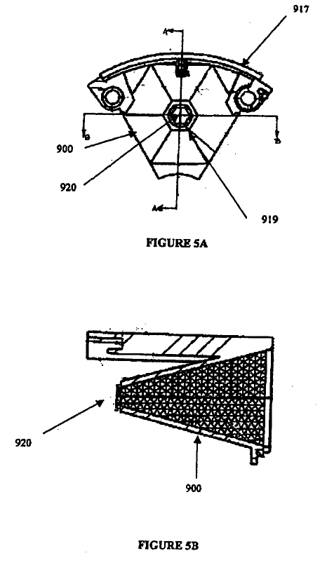

FIG. 4 illustrates a perspective view of a secondary optical element of the secondary optical system according to one embodiment of the present invention, wherein this secondary optical element 900 comprises a reflective optical surface formed as a “cone” having a hexagonal perpendicular cross sectional shape. The secondary optical element provides a means for light mixing, for example colour mixing, and collimating the light emitted by the tight-emitting elements associated therewith. The secondary optical element further comprises a perimeter wall 917, and mechanical indexing elements such as 905, 919 and 910 which can enable accurate and reproducible placement of the secondary optical element on a carrier to interface with the primary optical system. The indexing element may also provide a means for connection of multiple secondary optical elements, for example as illustrated in FIGS. 6 and 7. In one embodiment, the entrance aperture 920 may include indexing means 919 to aid in alignment of the secondary optical element with the primary optical system. It is understood that the secondary optical element 900 can be manufactured with more than one reflective “cones” to interface with more than one primary optical systems instead of assembling and interfacing several modular aforementioned arrangement of secondary optical elements as illustrated in FIGS. 6 and 7.

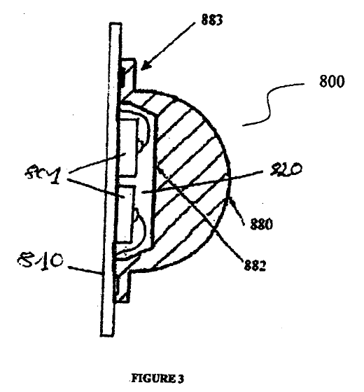

FIG. 5A is a bottom view of the secondary optical element illustrated in FIG. 4, wherein the light-emitting elements together with the primary optical system are aligned in the entrance aperture 920 defined within the secondary optical element. FIGS. 5B and 5C illustrate cross sectional views of the secondary optical element taken along lines A-A and B-B, respectively and indicate mechanical indexing features as well as the profile and taper of the of the optical surfaces from the entrance aperture out to the exit aperture. The optical surfaces are displayed cross-hatched and are coated with for example a relatively highly reflective material such as protected aluminium or protected silver in order to achieve relatively high optical efficiency. The dome section of the primary optical system illustrated in FIG. 3 can be fully or partially inserted into the secondary optical element which can provide for the capture of substantially a maximum amount of the light that is extracted by the primary optical system.

FIG. 6 illustrates an arrangement of secondary optical elements 900 according to FIG. 4. As illustrated, six secondary optical elements 900 are arranged adjacent to each other such that the first indexing means 905 of one secondary optical element is able to engage the second indexing means 910 of an adjacent secondary optical element. In this embodiment, the overall configuration of the arrangement of secondary optical elements is circular.

FIG. 7 illustrates a portion of the arrangement of secondary optical elements as depicted in FIG. 6, showing three of the secondary optical elements 900 arranged adjacent to each other.

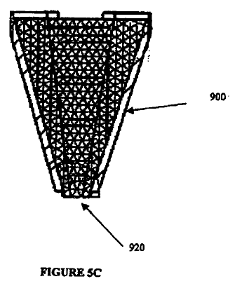

FIG. 8 is an elevated cross sectional view of a lighting module according to one embodiment, having a primary optical system as shown in FIG. 3, and the secondary optical system comprising the secondary optical element as depicted in FIG. 4, showing the alignment and mating of the primary optical system with a secondary optical element. The primary optical system is aligned with the entrance aperture 920 of the secondary optical system 900. The outer surface 880 of the dome lens extends into the entrance aperture 920. The shoulder 883 of the dome lens can allow for a mating point between the primary optical system and the secondary optical element 900.

In one embodiment of the present invention, a diffusive optical element can be placed anywhere along the optical path of the secondary optical element, for example proximal to the entrance aperture or exit aperture or anywhere there between of the secondary optical system.

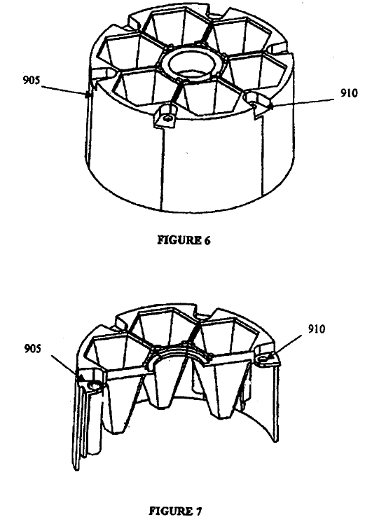

FIG. 9 illustrates a perspective view of a final secondary optical element which forms a part of the secondary optical system according to one embodiment of the present invention, wherein the final secondary optical element is plano-convex and configured to mate with the hexagonal cross sectional shaped secondary optical element illustrated in FIG. 4. It is understood that surfaces of the final secondary optical element can be aspheric, biconvex or tailored to achieve the desired optical performance. It is understood that a diffusive optical element such as a holographic diffuser of desired diffuser level can be attached to the piano side of the final secondary optical element to aid in the colour mixing. It is also understood that the diffusive properties can be integrated on the lens surfaces of the final secondary optical element and these properties can be integrated into the mould of the lens for the final secondary optical element. A final secondary optical element can be manufactured from any one or more of a plurality of materials, for example acrylic, polycarbonate, or BK7 glass, as would be readily known to a worker skilled in the art.

In one embodiment, antireflection coating of a final secondary optical element can further enhance efficiency of the final secondary optical element, for example by reflections on the face of the final secondary optical element adjacent to the secondary optical element.

In one embodiment, a final secondary optical element can be configured to provide a means for further blending of the light generated by the light-emitting elements. The final secondary optical element can contain one or more holographic diffusers or engineered lenticular arrays or volume diffusers, for example.

In one embodiment, a final secondary optical element is configured to provide a means for further collimation of the light generated by the light-emitting elements.

In one embodiment, a final secondary optical element is configured to provide a means for further shaping of the light beam generated by the light-emitting elements, for example shaping the light into a line of light or a beam of light illuminating a single quadrant of a surface area. For example, the final secondary optical element can be configured as a holographic diffuser with non-rotationally symmetric properties.

In one embodiment the final secondary optical element is configured to provide a means for further mixing of the angular distribution of the constituent chromaticities of the light-emitting elements as well as a means to aid in the beam collimation and shaping. For example, the final secondary optical element can be configured as a holographic diffuser with rotationally symmetric properties.

In one embodiment the final secondary optical element is configured to provide a means for sealing and protecting the reflective surfaces of the secondary optical element from the environment.

In one embodiment as illustrated in FIG. 9, the final secondary optical element can comprise an interfacing means 950 which can provide an indexed mating location for an optical element proximate to the final secondary optical element in order to sample a portion of the light emitted by the light-emitting elements of the lighting module, for subsequent feed back control of the lighting module.

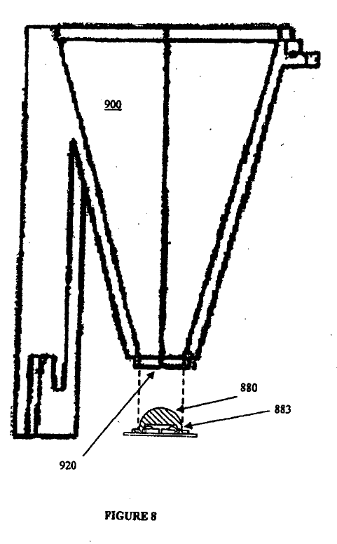

FIG. 10 illustrates an exploded view of a plurality of secondary optical systems, including an arrangement of a secondary optical elements together with final secondary optical elements which together can form the lighting module according to one embodiment of the present invention.

In one embodiment the plurality of arrangement secondary optical elements as illustrated in FIGS. 6 and 7 can be manufactured as one unit.

In one embodiment the plurality of final secondary optical elements as illustrated in FIG. 10 can be manufactured as one unit.

In one embodiment the final secondary optical element can be integral to a luminaire of lighting system and can optically communicate with the light emitted by a plurality of secondary optical elements.

It is also understood that the arrangement of secondary optical systems as illustrated in FIGS. 6, 7, and 10, can have a circular or any other shape desired for a particular luminaire or lighting system. For example, the arrangement of the secondary optical system can be rectangular, hexagonal or square and may be governed by the desired arrangement of the secondary optical systems. The modularity of the secondary optical systems and the hexagonal perpendicular cross sectional profile thereof can provide a means for scalability and high surface filling factor for a luminaire or lighting device comprising lighting modules including this format of secondary optical systems.

In one embodiment of the present invention a tertiary optical system is placed after the final secondary optical element to further manipulate the light beam. The tertiary optical system can be integral to the lighting module and optically communicate to all individual light beams generated two or more secondary optical systems of a light module as one. In another embodiment, the tertiary optical system can be integral to a luminaire that houses one or more light modules therein. In another embodiment, the tertiary optical system can be replacably and reproducibly mounted to a lighting module or luminaire.

### Example 2

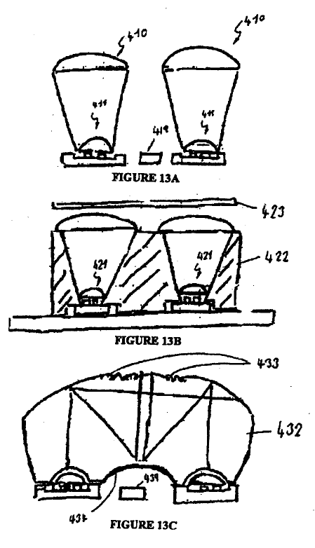

FIGS. 13A and 13B illustrate a lighting module according to embodiments of the present invention. FIG. 13A illustrates an elevated side view of two lighting modules 410, each having an individual primary optical system 411 and a secondary optical system 412 but can share a single tertiary optical system, which is not illustrated. The optical system comprises an optical feed back sensor 419, for example, a photo diode positioned in the center between the lighting modules.

FIG. 13B illustrates an elevated cross sectional view of a system comprising two or more separate primary optical systems 421 having one common integrally formed body 422 providing a common secondary optical system. The integrally formed body may allow optical communication to an optical feedback system within the secondary optical system 422. A tertiary optical system 423 is provided to further manipulate the light emitting from the lighting modules. An optical feedback sensor 421 can be placed between the two lighting modules and provisions can be made to guide a small portion of light representative of chromaticity and luminous flux output of the system to the sensor. The integrally formed body can contain two or more arrangement modules, for example six modules in a hexagonal arrangement.

FIG. 13C illustrates an elevated cross sectional view of part of a lighting module in which a single integrally formed body comprises a secondary optical system 432 which optically couples two primary optical systems, according to one embodiment of the present invention. The lighting module comprises an optical feed back sensor 439 positioned between the primary optical systems and in optical communication with the secondary optical system. The interface 433 of the secondary optical system on the far side of the light-emitting elements can be segmented in two sections, a first section annulus away from the axis of the system directing the beam towards the optical feed back sensor 439 and aiding in beam shaping and a second central section shaped to any form required to assist in refractive beam shaping, and it can be textured, embossed or otherwise structured to provide, for example, a Fresnel lens. The interface 434 of the secondary optical system on the near side of the optical feed back sensor can be shaped to any form to assist in the shaping of the output beam. Furthermore the interface 434 can be shaped to any form to assist in the extraction of light from the primary optics in the sections in proximity to the light-emitting elements and can be coated and shaped in sections in proximity to the feed back sensor 439 to assist in the extraction of an amount of light from the secondary optical system which is representative of the total light emitted by the lighting module and sufficient for reliable operation of the sensor element. This second interface can additionally be textured or otherwise structured. The sidewalls can be shaped or structured to aid in beam collimation and redirection. The surfaces or interfaces of the secondary optical system can be structured by means well known to one skilled in the art.

### Example 3

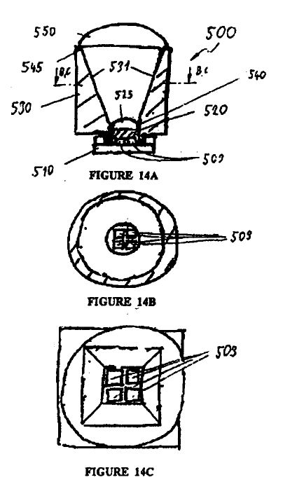

FIG. 14A illustrates an elevated cross sectional view of ft lighting module 500 according to an embodiment of the present invention. The lighting module comprises four light-emitting elements 503, for example, one red and one blue, and two green or one of each of red, green, amber, and blue colour, which are affixed to a substrate 510. The light-emitting elements are encapsulated by a refractive index matching material 520, for example, high refractive index silicone. The light-emitting elements are environmentally sealed between the substrate, the dome lens and the reflective element 530. Primary optical system and secondary optical system form an integral unit and are non-removable from the substrate with the dome lens 525 being affixed to the reflective element 530. The reflective element 530 can have a specular or diffuse reflective inner surface 531 extending from an entrance aperture 540 which widens into an exit aperture 545. The optical system additionally comprises a refractive optical element 550, for example, a planar-convex or any other lens, positioned proximal to the exit aperture of the mirror element. In addition, a diffuser element, which is not illustrated, can be positioned before or after the refractive optical element in the optical path.

FIG. 14B illustrates a perpendicular cross section of the lighting module in which the mirror element has a substantially circular shape. Alternatively, FIG. 14C illustrates a perpendicular cross section of the lighting module in which the secondary optical system comprises a mirror element having a substantially square shape. The dimensions of the optical system can be compact, for example, about 30 mm tall by about 20 mm across or in diameter.

One or more lighting modules having white or colour light-emitting elements can be operatively attached to a carrier to form a complete lighting system and electrically connected to a controller controlling the chromaticity and luminance of the lighting module through adjustment of the light output of the light-emitting elements.

### Example 4

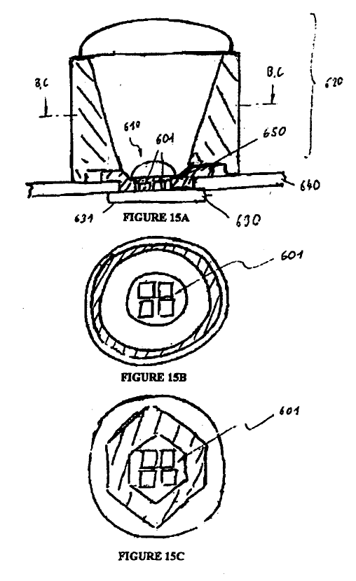

FIG. 15A illustrates an elevated cross sectional view of a lighting module according to another embodiment of the present invention. The lighting module comprises a primary optical system 610 as illustrated in FIG. 20 and a secondary 620 optical system similar to the embodiment illustrated in FIG. 14A. The light-emitting elements are encapsulated by a refractive index matching material, for example, relatively high refractive index silicone. The lighting module additionally comprises a substrate 630 which is positioned inferior to a carrier 640, for example on the side of the carrier opposite the secondary optical system. The substrate can provide a thermal interface 631 on the side opposite to the side of the substrate to which the light-emitting elements 601 are affixed. The thermal interface can be thermally connected to a thermal management system which is not illustrated. The lighting module further comprises an insert 650 having a reflective surface facing the light-emitting modules. In this specific embodiment, the carrier is an integral part of the primary optical system as a support member. FIGS. 15B and 15C illustrate perpendicular cross sections of embodiments of a secondary optical system for use with the lighting module as illustrated in FIG. 15A. FIGS. 15B and 15C illustrate a secondary optical system having a circular and hexagonal cross sectional shape, respectively.

### Example 5

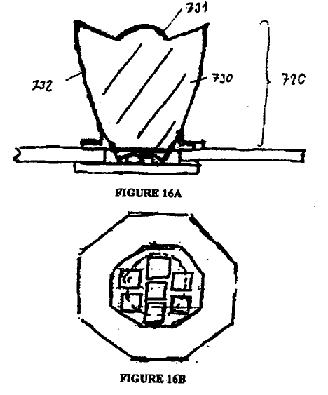

FIG. 16A illustrates an elevated view of a lighting module according to an embodiment of the present invention in which the secondary optical system 720 of the lighting module comprises a combination of reflective and refractive elements, namely a multi-functional solid optical element 730. The exit aperture of the solid optical element has a refractive element such as a macro-structured surface 731 circumscribed by a circumferential surface 732 of, for example, octagonal perpendicular cross section. The refractive element can be designed to provide any desired refractive functionality. It can also have a micro-structured surface that provides, for example, a translucent diffusive character. The input aperture of the solid refractive element can be flat or can be shaped like a negative dome or microlens array, for example. Encapsulation material with high refractive index can be inserted into the cavity between the light-emitting elements and the input aperture of the optic. A solid optical element can comprise a shaped output aperture and a shaped input aperture as indicated in FIG. 16A reducing the number of required parts to one optic only in comparison to a hollow optic system. The solid optical element 730 can be made such that the rays propagate by Total Internal Reflection or the wall surfaces can be coated such that high reflectivity is achieved.

The circumferential surface 732 can be specular or diffuse reflective, for example, the surface can be coated with reflective material or its surface can be structured or textured. FIG. 16B illustrates a top view of a lighting module having an octagonal cross section according to an embodiment as illustrated in FIG. 16A. It is also understood that the elevated cross section as shown in FIG. 16A can be parabolic, elliptical, hyperbolic or comprise individual straight or curved continuous conical segments, for example.

It is understood that a lighting module can have an alternatively shaped perpendicular cross section. It is also understood that the refractive element and other optical system components can be affixed to, for example, the substrate or the carrier or a tertiary optical system, via affixing technologies known in the art, which can secure the optical system components in a position relative to the light-emitting elements which is required for the effective extraction of light emitted by the light-emitting elements.

### Example 6

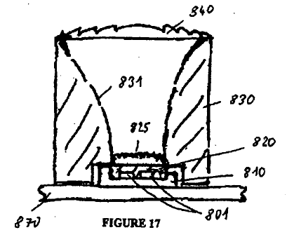

FIG. 17 illustrates an elevated cross sectional view of a lighting module according to another embodiment of the present invention. The lighting module comprises a secondary optical system comprising a hollow reflective element 830 having convex shaped inner reflective surface 831 extending between an entrance and an exit aperture. A Fresnel lens 840 covers the exit aperture which can improve beam collimation under operating conditions. A number of light-emitting elements 801 affixed to a substrate 810 are covered by a refractive index matching material 820 which is covered by a micro lens array element 825 which extends into the entrance aperture. The substrate is affixed to the top of a carrier 870. It is understood that the inner surface can be specular or diffuse reflective and that its shape can have any form required for effective colour mixing and collimation.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

I claim:

1. A lighting module comprising:
a) two or more light-emitting elements for generating light having one or more colours, said two or more light-emitting elements positioned into a closely packed array;
b) a primary optical system optically connected with the two or more light-emitting elements, said primary optical system providing a means for light extraction from the two or more light-emitting elements; and
c) a secondary optical system optically connected with the primary optical system, said secondary optical system for mixing and collimating the light extracted from the two or more light-emitting elements.

2. The lighting module according to claim 1, wherein the each of the two or more light-emitting elements emit light having a colour selected from the group comprising red, blue, green, amber and white.

3. The lighting module according to claim 1, wherein the two or more light-emitting elements have a longest dimension, and spacing between the two or more light-emitting elements is less than twice the longest dimension.

4. The lighting module according to claim 1, wherein the two or more light-emitting elements have a longest dimension, and spacing between the two or more light-emitting elements is less than the longest dimension.

5. The lighting module according to claim 1, wherein the two or more light-emitting elements have a longest dimension, and spacing between the two or more light-emitting elements is less than half of the longest dimension.

6. The lighting module according to claim 1, wherein the primary optical system includes an optical element, wherein said optical element is configured as a refractive element, reflective element, holographic element or diffractive element.

7. The lighting module according to claim 1, wherein the primary optical system is formed from an encapsulation material.

8. The lighting module according to claim 7, wherein the encapsulation material is patterned or textured.

9. The lighting module according to claim 6, wherein the primary optical system further comprises an encapsulation material positioned between the two more light-emitting elements and the optical element.

10. The lighting module according to claim 6, wherein the primary optical system comprises a dome lens enclosing the two or more light-emitting elements.

11. The lighting module according to claim 1, wherein the secondary optical system includes an optical element, wherein said optical element is configured as a refractive element, reflective element, holographic element, diffractive element or a diffusive element.

12. The lighting module according to claim 11, wherein the secondary optical system includes a light pipe or a light guide.

13. The lighting module according to claim 11, wherein the secondary optical system comprises a reflective element having reflective wall surfaces and a perpendicular cross section and an axial cross section.

14. The lighting module according to claim 13, wherein the perpendicular cross section is selected from the group comprising circular, square, hexagonal and octagonal.

15. The lighting module according to claim 13, wherein the reflective element has a symmetric axial cross sectional shape.

16. The lighting module according to claim 13, wherein the axial cross sectional shape flares or tapers at an exit aperture of the reflective element.

17. The lighting module according to claim 13, wherein the axial cross sectional shape is parabolic, elliptical, hyperbolic, straight, curved or segmented.

18. The lighting module according to claim 13, wherein the reflective element has a length and the secondary optical system further comprises a diffusive optical element positioned along the length.

19. The lighting module according to claim 1, wherein the primary optical system and the secondary optical system are integrally formed.

20. The lighting module according to claim 1, further comprising a tertiary optical system optically coupled to the secondary optical system, the tertiary optical system for shaping a beam of the mixed and collimated light extracted from the two or more light-emitting elements.

21. The lighting module according to claim 20, wherein the tertiary optical system comprises an optical element configured as a refractive element, diffractive element, diffusive element or holographic element.

22. The lighting module according to claim 20, wherein the tertiary optical system and the secondary optical system are configured for mating interconnection.
